(19) United States
(12) Patent Application Publication
(10) Pub. No.: US 2024/0340798 A1
(43) Pub. Date: Oct. 10, 2024

(54) COMMUNICATION METHOD AND APPARATUS

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 18/745,448

(22) Filed: Jun. 17, 2024

Related U.S. Application Data
(63) Continuation of application No. PCT/CN2021/138970, filed on Dec. 17, 2021.

(51) Int. Cl. H04W 52/02; H04W 76/28

(52) U.S. Cl. CPC H04W 52/0235; H04W 52/0248; H04W 76/28

(57) ABSTRACT

This application provides a communication method and apparatus. The method includes: A terminal device enters a low-power receiver state based on information of a target timer or indication information sent by a network device. At least one primary receiver of the terminal device in the low-power receiver state is in an off state. In this manner, the terminal device determines, based on the information of the target timer or the indication information sent by the network device, when to enter the low-power receiver state.

### CROSS-REFERENCE TO RELATED APPLICATIONS

This application is a continuation of International Application No. PCT/CN2021/138970, filed on Dec. 17, 2021, the disclosure of which is hereby incorporated by reference in its entirety.

### TECHNICAL FIELD

This application relates to the field of communications technologies, and in particular, to a communication method and apparatus.

### BACKGROUND

In 5G new radio (NR), a network side may configure a discontinuous reception (DRX) mechanism and a wake-up signal (WUS) mechanism for a terminal device, to achieve a power saving purpose of the terminal device. In the DRX mechanism, the terminal device discontinuously monitors a physical downlink control channel (PDCCH). In the WUS mechanism, the terminal device blindly detects a PDCCH-WUS at a fixed offset, and starts a DRX on duration timer (drx-onDurationTimer) based on the detected PDCCH-WUS, to determine a duration in which the terminal device is woken up in a DRX cycle.

In related technologies, an ultra-low power wake-up signal (LP-WUS) is proposed. In the WUS mechanism, a primary receiver of the terminal device is constantly in an on state. In comparison, in an LP-WUS mechanism, after the terminal device enters a low-power receiver state, the primary receiver may be turned off, to reduce power consumption of the primary receiver. Specifically, in the LP-WUS mechanism, only after receiving the LP-WUS, the terminal device starts the primary receiver to monitor a downlink signal, to achieve a power saving purpose.

However, in the LP-WUS mechanism, because the terminal device has two available receiver states, the terminal cannot determine when to enter the low-power receiver state.

### SUMMARY

Embodiments of this application provide a communication method and apparatus, to resolve a technical problem in the conventional technologies that a terminal device cannot determine when to enter a low-power receiver state.

A first aspect of this application provides a communication method. The method includes:
entering, by a terminal device, a low-power receiver state based on information of a target timer or indication information sent by a network device.

At least one primary receiver of the terminal device in the low-power receiver state is in an off state. The primary receiver is configured to receive and process a baseband signal and/or a radio frequency signal. Each primary receiver is separately associated with one master cell or one secondary cell.

In an optional implementation, the entering, by a terminal device, a low-power receiver state based on information of a target timer or indication information sent by a network device includes:
when the target timer expires, entering, by the terminal device, the low-power receiver state.

In an optional implementation, the target timer is started or restarted when the terminal device and the network device perform data transmission.

In an optional implementation, the target timer is associated with the terminal device or associated with a medium access control entity.

In an optional implementation, the entering, by a terminal device, a low-power receiver state based on information of a target timer includes:
if the target timer is associated with the terminal device, entering, by the terminal device, the low-power receiver state through turning off all primary receivers; or
if the target timer is associated with the medium access control entity, entering, by the terminal device, the low-power receiver state through turning off a primary receiver of a cell group corresponding to the medium access control entity associated with the target timer.

In an optional implementation, the medium access control entity includes a master cell group medium access control entity and/or a secondary cell group medium access control entity.

In an optional implementation, the target timer is started or restarted when a discontinuous reception group of the terminal device enters a long discontinuous reception cycle.

In an optional implementation, entering the long discontinuous reception cycle includes: entering the long discontinuous reception cycle from a short discontinuous reception cycle, and entering the long discontinuous reception cycle when the long discontinuous reception command medium access control control element is received.

In an optional implementation, the target timer is turned off when the discontinuous reception group of the terminal device enters a short discontinuous reception cycle or enters a discontinuous reception active state.

In an optional implementation, the discontinuous reception active state is triggered by scheduling of uplink and downlink data received in the long discontinuous reception cycle of the discontinuous reception group.

In an optional implementation, a timing duration of the target timer is a multiple of the long discontinuous reception cycle.

In an optional implementation, the entering, by a terminal device, a low-power receiver state based on information of a target timer includes:
entering, by the terminal device, the low-power receiver state through turning off a primary receiver corresponding to the discontinuous reception group.

In an optional implementation, the target timer is started when the terminal device turns on the primary receiver.

In an optional implementation, the indication information instructs all primary receivers of the terminal device to enter the low-power receiver state, or instructs a primary receiver corresponding to any medium access control entity to enter the low-power receiver state.

In an optional implementation, before the entering, by a terminal device, a low-power receiver state, the method further includes:
sending, by the terminal device, auxiliary information to the network device, where the auxiliary information is used to request to enter the low-power receiver state.

A second aspect of this application provides a communication method. The method includes:
sending, by a network device, indication information to a terminal device, where the indication information instructs the terminal device to enter a low-power receiver state.

At least one primary receiver of the terminal device in the low-power receiver state is in an off state. The primary receiver is configured to receive and process a baseband signal and/or a radio frequency signal. Each primary receiver is separately associated with one master cell or one secondary cell.

In an optional implementation, before the sending, by a network device, indication information to a terminal device, the method further includes:
receiving, by the network device, auxiliary information sent by the terminal device, where the auxiliary information is used to request to enter the low-power receiver state; and
determining, by the network device based on the auxiliary information and prediction information of uplink and downlink services, whether to generate the indication information.

A third aspect of this application provides a communications apparatus. The apparatus includes:
a processing module, configured to enable the communications apparatus to enter a low-power receiver state based on information of a target timer or indication information sent by a network device.

At least one primary receiver of the communications apparatus in the low-power receiver state is in an off state. The primary receiver is configured to receive and process a baseband signal and/or a radio frequency signal. Each primary receiver is separately associated with one master cell or one secondary cell.

In an optional implementation, the processing module is specifically configured to enter the low-power receiver state when the target timer expires.

In an optional implementation, the target timer is started or restarted when the communications apparatus and the network device perform data transmission.

In an optional implementation, the target timer is associated with the communications apparatus or associated with a medium access control entity.

In an optional implementation, the processing module is specifically configured to: if the target timer is associated with the communications apparatus, enter the low-power receiver state through turning off all primary receivers; or if the target timer is associated with the medium access control entity, enter the low-power receiver state through turning off a primary receiver of a cell group corresponding to the medium access control entity associated with the target timer.

In an optional implementation, the medium access control entity includes a master cell group medium access control entity and/or a secondary cell group medium access control entity.

In an optional implementation, the target timer is started or restarted when a discontinuous reception group of the communications apparatus enters a long discontinuous reception cycle.

In an optional implementation, entering the long discontinuous reception cycle includes: entering the long discontinuous reception cycle from a short discontinuous reception cycle, and entering the long discontinuous reception cycle when the long discontinuous reception command medium access control control element is received.

In an optional implementation, the target timer is turned off when the discontinuous reception group of the communications apparatus enters a short discontinuous reception cycle or enters a discontinuous reception active state.

In an optional implementation, the discontinuous reception active state is triggered by scheduling of uplink and downlink data received in the long discontinuous reception cycle of the discontinuous reception group.

In an optional implementation, a timing duration of the target timer is a multiple of the long discontinuous reception cycle.

In an optional implementation, the processing module is specifically configured to enter the low-power receiver state through turning off a primary receiver corresponding to the discontinuous reception group.

In an optional implementation, the target timer is started when the communications apparatus turns on the primary receiver.

In an optional implementation, the indication information instructs all primary receivers of the communications apparatus to enter the low-power receiver state, or instructs a primary receiver corresponding to any medium access control entity to enter the low-power receiver state.

In an optional implementation, the apparatus further includes:
a sending module, configured to send auxiliary information to the network device, where the auxiliary information is used to request to enter the low-power receiver state.

A fourth aspect of this application provides a communications apparatus. The apparatus includes:
a sending module, configured to send indication information to a terminal device, where the indication information instructs the terminal device to enter a low-power receiver state.

At least one primary receiver of the terminal device in the low-power receiver state is in an off state. The primary receiver is configured to receive and process a baseband signal and/or a radio frequency signal. Each primary receiver is separately associated with one master cell or one secondary cell.

In an optional implementation, the apparatus further includes:
a receiving module, configured to receive auxiliary information sent by the communications apparatus, where the auxiliary information is used to request to enter the low-power receiver state; and
a processing module, configured to determine, based on the auxiliary information and prediction information of uplink and downlink services, whether to generate the indication information.

A fifth aspect of this application provides a terminal device, including:
a processor, a memory, a receiver, and an interface for communicating with a network device.

The memory stores computer execution instructions.

The processor executes the computer execution instructions stored in the memory, so that the processor is enabled to perform the communication method according to any implementation of the first aspect.

A sixth aspect of this application provides a network device, including:
a processor, a memory, a receiver, and an interface for communicating with a terminal device.

The memory stores computer execution instructions.

The processor executes the computer execution instructions stored in the memory, so that the processor is enabled to perform the communication method according to any implementation of the second aspect.

A seventh aspect of this application provides a chip, including: a processor, configured to invoke a computer program from a memory and run the computer program, to enable a device installed with the chip to perform the method according to the first aspect.

An eighth aspect of this application provides a chip, including: a processor, configured to invoke a computer program from a memory and run the computer program, to enable a device installed with the chip to perform the method according to the second aspect.

A ninth aspect of this application provides a computer-readable storage medium, configured to store a computer program. A computer is enabled by using the computer program to perform the method according to the first aspect.

A tenth aspect of this application provides a computer-readable storage medium, configured to store a computer program. A computer is enabled by using the computer program to perform the method according to the second aspect.

An eleventh aspect of this application provides a computer program product, including computer instructions. The computer instructions are executed by a processor to implement the method according to the first aspect.

A twelfth aspect of this application provides a computer program product, including computer instructions. The computer instructions are executed by a processor to implement the method according to the second aspect.

A thirteenth aspect of this application provides a computer program. A computer is enabled by using the computer program to perform the method according to the first aspect.

A fourteenth aspect of this application provides a computer program. A computer is enabled by using the computer program to perform the method according to the second aspect.

A fifteenth aspect of this application provides an apparatus. The apparatus may include at least one processor and an interface circuit. Related program instructions are executed in the at least one processor, to enable the communications apparatus to implement the method according to the first aspect.

A sixteenth aspect of this application provides an apparatus. The apparatus may include at least one processor and an interface circuit. Related program instructions are executed in the at least one processor, to enable the communications apparatus to implement the method according to the second aspect.

A seventeenth aspect of this application provides a communications apparatus. The apparatus is configured to perform the method according to the first aspect.

An eighteenth aspect of this application provides a communications apparatus. The apparatus is configured to perform the method according to the second aspect.

According to the communication method and apparatus provided in embodiments of this application, the terminal device enters the low-power receiver state based on the information of the target timer or the indication information sent by the network device, where at least one primary receiver of the terminal device in the low-power receiver state is in the off state. In this manner, the terminal device may determine, based on the information of the target timer or the indication information sent by the network device, when to enter the low-power receiver state.

### BRIEF DESCRIPTION OF DRAWINGS

To describe the technical solutions in the present application or in the conventional technologies more clearly, the following briefly describes the accompanying drawings used to describe embodiments or the conventional technologies. It is clear that the accompanying drawings in the following descriptions show some embodiments of the present application, and persons of ordinary skill in the art may still derive other drawings from these accompanying drawings without creative efforts.

FIG. 1 is a schematic diagram of a scenario of a communication method according to an embodiment of this application.

FIG. 2 is a schematic flowchart of a communication method according to an embodiment of this application.

FIG. 3 is a diagram of signaling interaction of a communication method according to an embodiment of this application.

FIG. 4 is a schematic diagram of a target timer according to an embodiment of this application.

FIG. 5 is a diagram of signaling interaction of another communication method according to an embodiment of this application.

FIG. 6 is a schematic diagram of another target timer according to an embodiment of this application.

FIG. 7 is a diagram of signaling interaction of another communication method according to an embodiment of this application.

FIG. 8 is a schematic diagram of a structure of a communications apparatus according to an embodiment of this application.

FIG. 9 is a schematic diagram of a structure of another communications apparatus according to an embodiment of this application.

FIG. 10 is a schematic diagram of a structure of a communications device according to an embodiment of this application.

### DESCRIPTION OF EMBODIMENTS

To make the objectives, technical solutions, and advantages of the present application clearer, the following clearly and fully describes the technical solutions in embodiments of the present application with reference to the accompanying drawings of embodiments of the present application. Apparently, the described embodiments are some but not all of embodiments of the present application. Based on embodiments of the present application, all other embodiments obtained by those of ordinary skill in the art without creative effort fall within the protection scope of the present application.

In the specification, claims, and accompanying drawings of embodiments of this application, the terms “first”, “second”, and the like are intended to distinguish between similar objects but do not necessarily indicate a specific order or sequence. It should be understood that data used in this way is interchangeable under appropriate circumstances, so that embodiments of this application described herein can be, for example, implemented in an order different from the order illustrated or described herein. In addition, the terms “include”, “have”, and any other variant thereof are intended to cover the non-exclusive inclusion. For example, a process, method, system, product, or device that includes a list of steps or units is not necessarily limited to those steps or units that are expressly listed, but may include other steps or units that are not expressly listed or inherent to the process, method, product, or device.

It should be understood that the terms “system” and “network” in this specification may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application.

The following first describes 5G NR DRX.

In 5G NR, a network side may configure a DRX function for a terminal device, so that the terminal device discontinuously monitors a PDCCH, to achieve a power saving purpose of the terminal. Each medium access control (MAC) entity has one DRX configuration. DRX includes the following configuration parameters.

A DRX on duration timer (drx-onDurationTimer) is used to represent a duration in which the terminal device is woken up in a DRX cycle.

A DRX time domain offset (drx-SlotOffset) is used to represent a delay of drx-onDurationTimer.

A DRX inactivity timer (drx-InactivityTimer) is used to represent a duration in which the terminal device continuously monitors a PDCCH after the terminal device receives a PDCCH that indicates uplink initial transmission or downlink initial transmission.

A DRX downlink retransmission timer (drx-RetransmissionTimerDL) is used to represent a maximum duration in which the terminal device monitors a PDCCH that indicates downlink retransmission scheduling. Each downlink HARQ process other than a hybrid automatic repeat request (HARQ) broadcast process corresponds to drx-RetransmissionTimerDL.

A DRX uplink retransmission timer (drx-RetransmissionTimerUL) is used to represent a maximum duration in which the terminal device monitors a PDCCH that indicates uplink retransmission scheduling. Each uplink HARQ process corresponds to drx-RetransmissionTimerUL.

A long DRX cycle start offset (drx-LongCycleStartOffset) is used to configure a long DRX cycle, and subframe offsets starting from the long DRX cycle and a short DRX cycle.

A short DRX cycle timer (drx-ShortCycleTimer) is used to represent a duration in which the terminal device is in the short DRX cycle and does not receive any PDCCH. Both drx-ShortCycleTimer and the short DRX cycle (drx-ShortCycle) are optional configurations.

A DRX HARQ round-trip time downlink timer (drx-HARQ-RTT-TimerDL) is used to represent a minimum waiting time that is needed by the terminal device that expects to receive a PDCCH that indicates downlink scheduling. Each downlink HARQ process other than a HARQ broadcast process corresponds to drx-HARQ-RTT-TimerDL.

A DRX HARQ round-trip time uplink timer (drx-HARQ-RTT-TimerUL) is used to represent a minimum waiting time that is needed by the terminal device that expects to receive a PDCCH that indicates uplink scheduling. Each uplink HARQ process corresponds to drx-HARQ-RTT-TimerUL.

It should be understood that the terminal needs to monitor a PDCCH in a DRX active time if DRX is configured on the terminal device. The DRX active time includes the following three cases:
1. Any of five timers: drx-onDurationTimer, drx-InactivityTimer, drx-RetransmissionTimerDL, drx-RetransmissionTimerUL, and ra-ContentionResolutionTimer is running.
2. A scheduling request (SR) is sent on the PUCCH, and is in a pending state.
3. In a contention-based random access procedure, after successfully receiving a random access response, the terminal device has not received an initial transmission indicated by a PDCCH scrambled by using a cell radio network temporary identifier (C-RNTI).

It should be understood that the terminal device determines, based on whether the terminal device is currently in a short DRX cycle or a long DRX cycle, a time for starting drx-onDurationTimer. In some embodiments, if the short DRX cycle is used and a current subframe meets [(SFN×10)+subframe number] modulo (drx-ShortCycle)=(drx-StartOffset) modulo (drx-ShortCycle), or if the long DRX cycle is used and a current subframe meets [(SFN×10)+subframe number] modulo (drx-LongCycle)=drx-StartOffset, drx-onDurationTimer is started at a moment after drx-SlotOffset slots after the current subframe starts.

It should be understood that the terminal device starts or restarts drx-InactivityTimer if the terminal device receives a PDCCH that indicates downlink or uplink initial transmission.

It should be understood that the terminal device stops drx-RetransmissionTimerDL corresponding to the HARQ process, when the terminal device receives a PDCCH that indicates downlink transmission, or when the terminal device receives a MAC protocol data unit (PDU) on a configured downlink grant resource. After completing transmission for HARQ process feedback of the downlink transmission, the terminal device starts drx-HARQ-RTT-TimerDL corresponding to the HARQ process. If a drx-HARQ-RTT-TimerDL timer corresponding to a specific HARQ of the terminal expires and downlink data transmitted by using the HARQ process fails to be decoded, the terminal device starts drx-RetransmissionTimerDL corresponding to the HARQ process.

Correspondingly, when the terminal device receives a PDCCH that indicates uplink transmission, or when the terminal device sends a MAC PDU on a configured uplink grant resource, the terminal stops drx-RetransmissionTimerUL corresponding to the HARQ process. After completing a first time of repetition of the PUSCH, the terminal device starts drx-HARQ-RTT-TimerUL corresponding to the HARQ process. If a drx-HARQ-RTT-TimerUL timer corresponding to a specific HARQ of the terminal device expires, the terminal device starts drx-RetransmissionTimerUL corresponding to the HARQ process.

It should be noted that in an existing mechanism, the long DRX cycle is a default configuration, and the short DRX cycle is an optional configuration. For a terminal device configured with the long DRX cycle, a conversion manner between the long DRX cycle and the short DRX cycle is specified in a current protocol as follows:

If a drx-InactivityTimer expires and/or the terminal device receives a discontinuous reception command medium access control control element (DRX Command MAC CE), the terminal device uses the short DRX cycle.

If a drx-ShortCycleTimer expires and/or the terminal device receives a long discontinuous reception command medium access control control element (long DRX Command MAC CE), the terminal device uses the long DRX cycle.

The following describes a connected-mode WUS signal.

In NR R16, a power saving signal is introduced. Before starting a drx-ondurationTimer, the terminal device blindly detects a PDCCH based on the power saving signal (PDCCH-WUS) at a fixed offset. If the PDCCH-WUS is detected and the WUS instructs the terminal device to start drx-ondurationTimer, the terminal device starts drx-ondurationTimer; or otherwise, the terminal device does not start drx-ondurationTimer.

In related technologies, an ultra-low power wake-up signal (LP-WUS) is proposed. In the WUS mechanism, a primary receiver of the terminal device is constantly in an on state. In comparison, in an LP-WUS mechanism, after the terminal device enters a low-power receiver state, the primary receiver may be turned off, to reduce power consumption of the primary receiver. Specifically, in the LP-WUS mechanism, only after receiving the LP-WUS, the terminal device starts the primary receiver to monitor a downlink signal, to achieve a power saving purpose.

However, in the LP-WUS mechanism, because the terminal device has two available receiver states, the terminal cannot determine when to enter the low-power receiver state.

To resolve the foregoing technical problem, embodiments of this application provide a communication method and apparatus. A terminal device determines, based on information of a target timer or indication information sent by a network device, an opportunity for entering a low-power receiver state.

The following uses an example to describe an application scenario of this application.

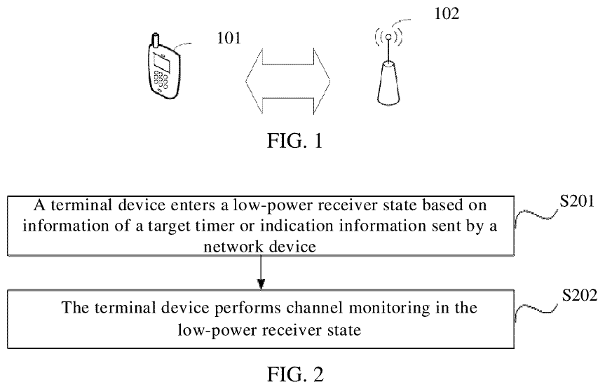

FIG. 1 is a schematic diagram of a scenario of a communication method according to an embodiment of this application. As shown in FIG. 1, a terminal device 101 communicates with a network device 102. When discontinuously monitoring a PDCCH, the terminal device 101 enters a low-power receiver state based on information of a target timer or indication information sent by the network device 102, and turns off at least one primary receiver of the terminal device 101.

The terminal device 101 includes but is not limited to a satellite or cellular phone, a personal communications system (PCS) terminal that may combine a cellular wireless phone with data processing, a fax, and a data communication capability; a PDA that may include a wireless phone, a pager, Internet/Intranet access, a web browser, a notebook, a calendar, and/or a global positioning system (GPS) receiver; and a conventional laptop and/or palmtop receiver or another electronic apparatus including a wireless telephone transceiver. The terminal device may be an access terminal, user equipment (UE), a subscriber unit, a subscriber station, a mobile site, a mobile station, a remote station, a remote terminal, a mobile device, a user terminal, a terminal, a wireless communications device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a 5G network, a terminal device in a future evolved PLMN, or the like.

The network device 102 may provide communication coverage for a specific geographic area, and may communicate with a terminal device within the coverage area. Optionally, the network device 102 may be a base transceiver station (BTS) in a GSM system or a CDMA system, may be a NodeB (NB) in a WCDMA system, or may be an evolved NodeB (eNB or eNodeB) in an LTE system, or a radio controller in a cloud radio access network (CRAN). Alternatively, the network device may be a mobile switching center, a relay station, an access point, a vehicle-mounted device, a wearable device, a concentrator, a switch, a bridge, a router, a network device in a 5G network, a network device in a future evolved public land mobile network (PLMN), or the like.

The following uses a communications device such as a terminal device or a network device as an example to describe the technical solutions in embodiments of this application in detail by using specific embodiments. For the following several specific embodiments, mutual reference may be made. Same or similar concepts or processes may be not described again in some embodiments.

FIG. 2 is a schematic flowchart of a communication method according to an embodiment of this application. This embodiment of this application is executed by a terminal device, and relates to a process of how the terminal device determines to enter a low-power receiver state. As shown in FIG. 2, the method includes the following steps:
S201: The terminal device enters the low-power receiver state based on information of a target timer or indication information sent by a network device.

At least one primary receiver of the terminal device in the low-power receiver state is in an off state.

It should be understood that the primary receiver is configured to obtain a needed signal from a plurality of received signals through screening, suppress or filter out an unneeded interference signal or noise, and then process the needed signal. In some embodiments, the primary receiver is configured to receive and process a baseband signal and/or a radio frequency signal (for example, the primary receiver receives a signal such as a PDCCH). Each primary receiver is respectively associated with one master cell or one secondary cell.

This embodiment of this application provides three manners in which the terminal device enters the low-power receiver state.

In a first manner, a terminal device side maintains a target timer and starts or restarts the target timer in each time of data transmission, and the terminal device enters the low-power receiver state when the target timer expires.

It should be understood that a type of the target timer is not limited in this embodiment of this application, and the target timer may be a low-power receiver state timer (LP-WUS Inactivity Timer).

It should be understood that a type of data transmitted between the terminal device and the network device is not limited in this embodiment of this application. In some embodiments, the data transmitted between the terminal device and the network device includes: a medium access control protocol data unit (MAC SDU) received by any medium access control entity from a logical channel, and/or a MAC SDU sent by any medium access control entity from a logical channel.

The logical channel may include a dedicated service channel, a dedicated control channel, or a common control channel. The medium access control entity may include a master cell group (MCG) MAC entity and/or a secondary cell group (SCG) MAC entity.

It should be noted that the target timer related in this embodiment of this application may be associated with the terminal device, or may be associated with the medium access control entity. This is not limited in this embodiment of this application.

Correspondingly, in some embodiments, when data transmission is performed between the terminal device and the network device, the terminal device starts or restarts the target timer associated with the terminal device. In other words, the target timer is a terminal device-level timer. In some other embodiments, when data transmission is performed between the terminal device and the network device, the terminal device starts or restarts a target timer associated with the medium access control entity. In other words, the target timer is an MCG timer or an SCG timer.

For different target timers, the terminal device may enter the low-power receiver state in different manners.

In some embodiments, if the target timer is associated with the terminal device, the terminal device enters the low-power receiver state through turning off all primary receivers. If the target timer is associated with the medium access control entity, the terminal device enters the low-power receiver state through turning off a primary receiver of a cell group corresponding to the medium access control entity associated with the target timer.

It should be understood that this embodiment of this application also limits when the target timer is turned on. In some embodiments, the target timer is started when the terminal device turns on the primary receiver.

It should be noted that the target timer in the first manner may be configured by the network device by using configuration information.

In a second manner, the terminal device maintains a target timer, and a timing duration of the target timer is a multiple of a long discontinuous reception cycle. If the terminal device does not have service transmission in the timing duration of the target timer, the terminal device enters the low-power receiver state.

It should be understood that the timing duration of the target timer is not limited in this embodiment of this application, and may be the multiple of the long discontinuous reception cycle, for example, one long DRX cycle, two long DRX cycles, and five long DRX cycles.

It should be understood that trigger conditions for starting, restarting, and turning off the target timer are not limited in this embodiment of this application. In some embodiments, the target timer is started or restarted when a DRX group of the terminal device enters the long DRX cycle, and is turned off when the DRX group of the terminal device enters the short DRX cycle or enters a discontinuous reception active (DRX active) state.

Entering the long DRX cycle includes entering the long DRX cycle from the short DRX cycle, and entering the long DRX cycle when a long discontinuous reception command medium access control control element (Long DRX Command MAC CE) is received. The DRX active state is triggered by scheduling of uplink and downlink data received in the long DRX cycle of the DRX group.

In some embodiments, for the target timer whose timing duration is the multiple of the long DRX cycle, the terminal device may enter the low-power receiver state through turning off a primary receiver corresponding to the DRX group.

It should be noted that the target timer in the second manner may also be configured by the network device by using configuration information.

In the first case and the second case, in a manner of introducing an implicit timer, when the terminal device has no service transmission in a period of time, the terminal device may enter a low power saving state, to help power saving for the terminal device without affecting service transmission as much as possible. In addition, signaling overheads are not increased in the manner of the implicit timer.

In a third manner, the terminal device in a connected mode may receive indication information of the network device, and the network device instructs the terminal device to enter the low-power receiver state.

It should be understood that a type of the indication information is not limited in this embodiment of this application. In some embodiments, the indication information instructs all primary receivers of the terminal device to enter the low-power receiver state, or instructs a primary receiver corresponding to any medium access control entity to enter the low-power receiver state.

For example, the indication information may separately instruct all terminal device-level receivers, or MCG receivers or SCG receivers whether to enter the low-power receiver state.

It should be understood that a manner of sending the indication information is not limited in this embodiment of this application. In some embodiments, the indication information is carried in a MAC CE, a PDCCH, or radio resource control (RRC) dedicated signaling.

In some embodiments, before the terminal device enters the low-power receiver state, the terminal device may further send auxiliary information to the network device. The auxiliary information is used to request to enter the low-power receiver state. The network device determines, based on the auxiliary information and prediction information of uplink and downlink services, whether to generate the indication information.

In a third case, in a manner of explicit signaling of the indication information, unnecessary prediction presentations can be reduced, to enter a low power saving state and better help power saving of the terminal device.

S202: The terminal device performs channel monitoring in the low-power receiver state.

According to the communication method and apparatus provided in embodiments of this application, the terminal device enters the low-power receiver state based on the information of the target timer or the indication information sent by the network device. At least one primary receiver of the terminal device in the low-power receiver state is in an off state. In this manner, the terminal device determines, based on the information of the target timer or the indication information sent by the network device, when to enter the low-power receiver state.

Based on the foregoing embodiments, the following specifically describes the foregoing three manners in which the terminal device enters the low-power receiver state.

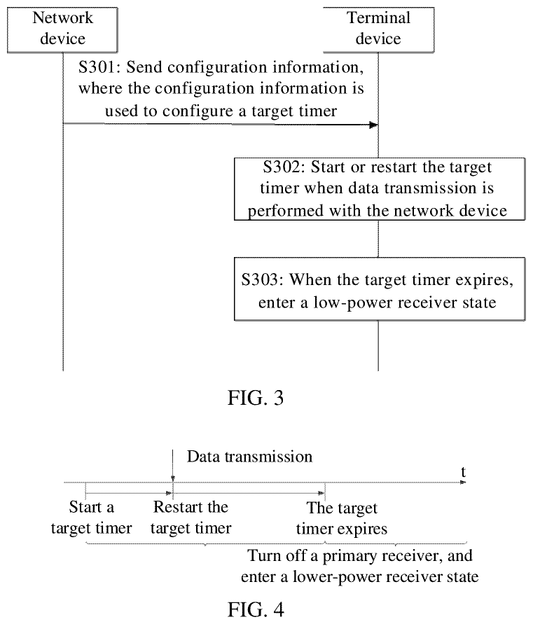

FIG. 3 is a diagram of signaling interaction of a communication method according to an embodiment of this application. FIG. 4 is a schematic diagram of a target timer according to an embodiment of this application. This embodiment of this application describes the foregoing first manner in which the terminal device enters the low-power receiver state. As shown in FIG. 3 or FIG. 4, the communication method includes the following steps:

S301: A network device sends configuration information to a terminal device. The configuration information is used to configure a target timer.

A timing duration of the target timer is not limited in this embodiment, and may be specifically set according to an actual case. For example, the timing duration of the target timer may be set to 10 seconds, 30 seconds, or 1 minute.

S302: The target timer is started or restarted when the terminal device and the network device perform data transmission.

In this embodiment, the terminal device and the network device perform data transmission when a primary receiver is in an on state. If any MAC entity (for example, MCG MAC or SCG MAC) receives a MAC SDU from a DTCH logical channel, a DCCH logical channel, or a CCCH logical channel, or if any MAC entity (MCG MAC or SCG MAC) sends a MAC SDU from a DTCH logical channel or a DCCH logical channel, the target timer is started or restarted.

The target timer is associated with the terminal device or associated with the medium access control entity.

S303: When the target timer expires, the terminal device enters a low-power receiver state.

In some embodiments, if the target timer is associated with the terminal device, the terminal device enters the low-power receiver state through turning off all primary receivers. In some other embodiments, if the target timer is associated with the medium access control entity, the terminal device enters the low-power receiver state through turning off a primary receiver of a cell group corresponding to the medium access control entity associated with the target timer.

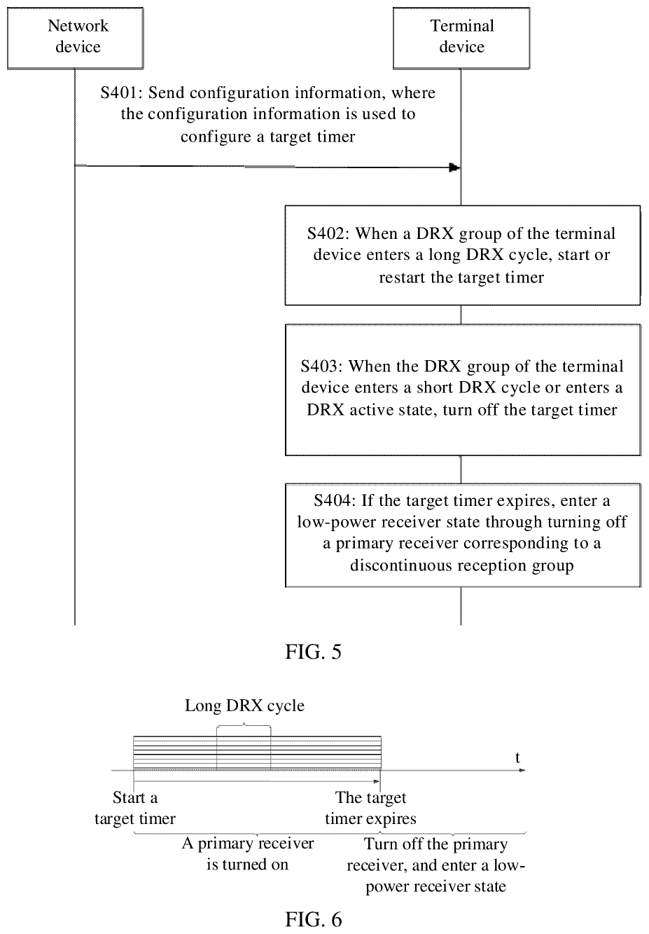

FIG. 5 is a diagram of signaling interaction of another communication method according to an embodiment of this application. FIG. 6 is a schematic diagram of another target timer according to an embodiment of this application. This embodiment of this application describes the foregoing second manner in which the terminal device enters the low-power receiver state. As shown in FIG. 5 or FIG. 6, the communication method includes the following steps:

S401: A network device sends configuration information to a terminal device. The configuration information is used to configure a target timer.

A timing duration of the target timer is a multiple of a long DRX cycle.

S402: When a DRX group of the terminal device enters the long DRX cycle, the terminal device starts or restarts the target timer.

It should be understood that a type of the DRX group is not limited in this embodiment of this application, and may be an MCG DRX group or an SCG DRX group.

It should be understood that this embodiment of this application also does not limit how to enter the long DRX cycle. In some embodiments, entering the long DRX cycle from a short DRX cycle and entering the long discontinuous reception cycle when the long DRX cycle is received may be included, to restart the target timer related to the DRX group.

S403: When the DRX group of the terminal device enters the short DRX cycle or enters a DRX active state, the terminal device turns off the target timer.

It should be understood that this embodiment of this application does not limit how to enter the DRX active state. In some embodiments, the DRX active state is triggered by scheduling of uplink and downlink data received in the long DRX cycle of the DRX group, or the DRX group may enter the DRX active state for another reason.

It should be understood that this embodiment of this application also does not limit how the DRX group enters the short DRX cycle. In some embodiments, the DRX group may enter the short DRX cycle when a DRX command MAC CE is received.

S404: If the target timer expires, the terminal device enters a low-power receiver state through turning off a primary receiver corresponding to the discontinuous reception group.

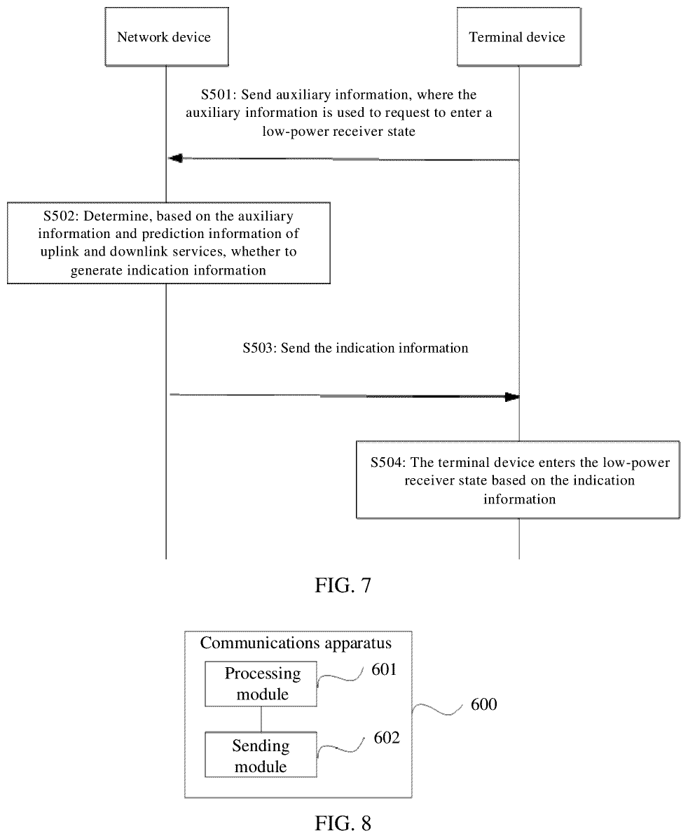

FIG. 7 is a diagram of signaling interaction of another communication method according to an embodiment of this application. This embodiment of this application describes the foregoing third manner in which the terminal device enters the low-power receiver state. As shown in FIG. 7, the communication method includes the following steps:

S501: The terminal device sends auxiliary information to a network device. The auxiliary information is used to request to enter the low-power receiver state.

In this embodiment of this application, when the terminal device predicts that there is no uplink or downlink service transmission in a future period of time, the terminal device may report the auxiliary information to the network device to request to enter the low-power receiver state.

S502: The network device determines, based on the auxiliary information and prediction information of uplink and downlink services, whether to generate indication information.

This embodiment of this application does not limit how to predict whether to generate the indication information. In some embodiments, based on the auxiliary information and the prediction information of the uplink and downlink services, the network device may predict whether to perform data transmission with the terminal device in a future period of time. If data transmission is sent to the terminal device in the future period of time, the indication information is not generated. If data transmission is not sent to the terminal device in the future period of time, the indication information is generated.

S503: The network device sends the indication information to the terminal device.

S504: The terminal device enters the low-power receiver state based on the indication information.

At least one primary receiver of the terminal device in the low-power receiver state is in an off state.

According to the communication method and apparatus provided in embodiments of this application, the terminal device enters the low-power receiver state based on information of a target timer or the indication information sent by the network device. The at least one primary receiver of the terminal device in the low-power receiver state is in the off state. In this manner, the terminal device determines, based on the information of the target timer or the indication information sent by the network device, when to enter the low-power receiver state.

FIG. 8 is a schematic diagram of a structure of a communications apparatus according to an embodiment of this application. The communications apparatus may be implemented by using software, hardware, or a combination thereof, to perform the communication method on a terminal device side in the foregoing embodiments. The communications apparatus may be the foregoing terminal device. As shown in FIG. 8, the communications apparatus 600 includes a processing module 601 and a sending module 602.

The processing module 601 is configured to enter a low-power receiver state based on information of a target timer or indication information sent by a network device.

The at least one primary receiver of the communications apparatus in the low-power receiver state is in an off state.

In an optional implementation, the processing module 601 is specifically configured to enter the low-power receiver state when the target timer expires.

In an optional implementation, the target timer is started or restarted when the communications apparatus and the network device perform data transmission.

In an optional implementation, the target timer is associated with the communications apparatus or associated with a medium access control entity.

In an optional implementation, the processing module 601 is specifically configured to: if the target timer is associated with the communications apparatus, enter the low-power receiver state through turning off all primary receivers; or if the target timer is associated with the medium access control entity, enter the low-power receiver state through turning off a primary receiver of a cell group corresponding to the medium access control entity associated with the target timer.

In an optional implementation, the medium access control entity includes a master cell group medium access control entity and/or a secondary cell group medium access control entity.

In an optional implementation, the target timer is started or restarted when a discontinuous reception group of the communications apparatus enters a long discontinuous reception cycle.

In an optional implementation, entering the long discontinuous reception cycle includes: entering the long discontinuous reception cycle from a short discontinuous reception cycle, and entering the long discontinuous reception cycle when the long discontinuous reception command medium access control control element is received.

In an optional implementation, the target timer is turned off when the discontinuous reception group of the communications apparatus enters a short discontinuous reception cycle or enters a discontinuous reception active state.

In an optional implementation, the discontinuous reception active state is triggered by scheduling of uplink and downlink data received in the long discontinuous reception cycle of the discontinuous reception group.

In an optional implementation, a timing duration of the target timer is a multiple of the long discontinuous reception cycle.

In an optional implementation, the processing module 601 is specifically configured to enter the low-power receiver state through turning off a primary receiver corresponding to the discontinuous reception group.

In an optional implementation, the target timer is started when the communications apparatus turns on the primary receiver.

In an optional implementation, the indication information instructs all primary receivers of the communications apparatus to enter the low-power receiver state, or instructs a primary receiver corresponding to any medium access control entity to enter the low-power receiver state.

In an optional implementation, the communications apparatus 600 further includes:
a sending module 602, configured to send auxiliary information to the network device, where the auxiliary information is used to request to enter the low-power receiver state.

The communications apparatus provided in this embodiment of this application may perform actions in the communication method on the terminal device side in the foregoing embodiments. Implementation principles and technical effects thereof are similar, and details are not described herein again.

FIG. 9 is a schematic diagram of a structure of another communications apparatus according to an embodiment of this application. The communications apparatus may be implemented by using software, hardware, or a combination thereof, to perform the communication method on a network device side in the foregoing embodiments. The communications apparatus may be the foregoing network device. As shown in FIG. 9, the communications apparatus 700 includes a sending module 701, a receiving module 702, and a processing module 703.

The sending module 701 is configured to send indication information to a terminal device. The indication information instructs the terminal device to enter a low-power receiver state.

The at least one primary receiver of the terminal device in the low-power receiver state is in an off state.

In an optional implementation, the communications apparatus 700 further includes:
the receiving module 702, configured to receive auxiliary information sent by the terminal device, where the auxiliary information is used to request to enter the low-power receiver state; and
the processing module 703, configured to determine, based on the auxiliary information and prediction information of uplink and downlink services, whether to generate indication information.

The communications apparatus provided in this embodiment of this application may perform actions in the communication method on the network device side in the foregoing embodiments. Implementation principles and technical effects thereof are similar, and details are not described herein again.

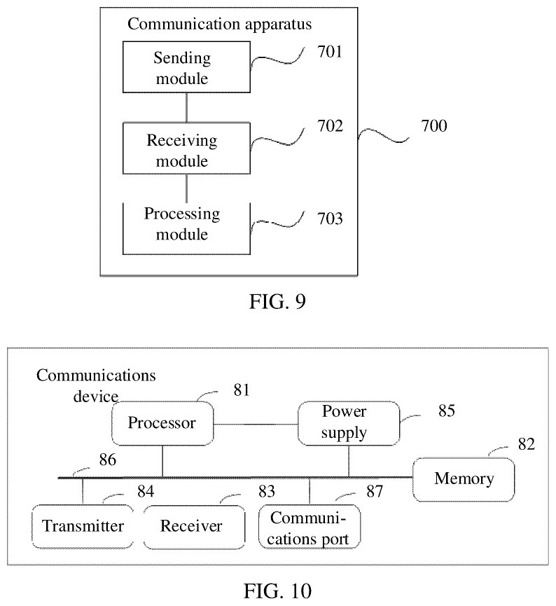

FIG. 10 is a schematic diagram of a structure of a communications device according to an embodiment of this application. As shown in FIG. 10, the communications device may include a processor 81 (for example, a CPU), a memory 82, a receiver 83, and a transmitter 84.

The receiver 83 and the transmitter 84 are coupled to the processor 81. The processor 81 controls a receiving action of the receiver 83, and the processor 81 controls a sending action of the transmitter 84. The memory 82 may include a high-speed RAM memory, and may further include a non-volatile memory NVM, for example, at least one disk memory. The memory 82 may store various types of information for completing various processing functions and implement the method steps in embodiments of this application. Optionally, the electronic device in this embodiment of this application may further include a power supply 85, a communications bus 86, and a communications port 87. The receiver 83 and the transmitter 84 may be integrated into a transceiver of the electronic device, or may be an independent transceiver antenna of the electronic device. The communications bus 86 is configured to implement communication connection between components. The communications port 87 is configured to implement connection and communication between the electronic device and another peripheral device.

In this embodiment of this application, the memory 82 is configured to store computer-executable program code. The program code includes information. When the processor 81 executes the information, the processor 81 is enabled by using the information to perform a processing action on the terminal device side in the foregoing method embodiments, the transmitter 84 is enabled by using the information to perform a sending action on the terminal device side in the foregoing method embodiments, and the receiver 83 is enabled by using the information to perform a receiving action on the terminal device side in the foregoing method embodiments. Implementation principles and technical effects thereof are similar, and details are not described herein again.

Alternatively, when the processor 81 executes the information, the processor 81 is enabled by using the information to perform a processing action on the network device side in the foregoing method embodiments, the transmitter 84 is enabled by using the information to perform a sending action on the network device side in the foregoing method embodiments, and the receiver 83 is enabled by using the information to perform a receiving action on the network device side in the foregoing method embodiments. Implementation principles and technical effects thereof are similar, and details are not described herein again.

An embodiment of this application further provides a communications system, including a terminal device and a network device, to perform the foregoing communication method.

An embodiment of this application further provides a chip, including a processor and an interface. The interface is configured to input and output data or instructions processed by the processor. The processor is configured to perform the method provided in the foregoing method embodiments. The chip may be used in the foregoing communications apparatus.

The present application further provides a computer-readable storage medium. The computer-readable storage medium may include any medium that can store program code, for example, a USB flash drive, a removable hard disk, a read-only memory (ROM), a random access memory (RAM), a magnetic disk, or an optical disc. Specifically, the computer-readable storage medium stores program information. The program information is used in the foregoing communication method.

An embodiment of this application further provides a program, and the program is used to perform the communication method provided in the foregoing method embodiments when being executed by a processor.

An embodiment of this application further provides a program product, such as a computer-readable storage medium. The program product stores instructions. When the instructions are run on a computer, the computer is enabled to perform the communication method provided in the foregoing method embodiments.

An embodiment of this application further provides an apparatus. The apparatus may include at least one processor and an interface circuit. Related program instructions are executed in the at least one processor, so that the communications apparatus implements the communication method provided in the foregoing method embodiments.

An embodiment of this application further provides a communications apparatus, and the apparatus is configured to perform the communication method provided in the foregoing method embodiments.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions.

When the computer program instructions are loaded and executed on a computer, the processes or functions described according to embodiments of the present application are all or partly generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any available medium accessible by a computer or a data storage device such as a server or a data center that integrates one or more available media. The usable medium may be a magnetic medium (for example, a floppy disk, a hard disk drive, or a magnetic tape), an optical medium (for example, a DVD), a semiconductor medium (for example, a solid state disk (SSD)), or the like.

In conclusion, it should be noted that the above embodiments are merely intended for describing the technical solutions of the present application but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of the present application.

What is claimed is:

1. A communication method, comprising:
entering, by a terminal device, a low-power receiver state based on information of a target timer or indication information sent by a network device, wherein
at least one primary receiver of the terminal device in the low-power receiver state is in an off state.

2. The method according to claim 1, wherein the entering, by a terminal device, a low-power receiver state based on information of a target timer or indication information sent by a network device comprises:
when the target timer expires, entering, by the terminal device, the low-power receiver state.

3. The method according to claim 2, wherein the target timer is started or restarted when the terminal device and the network device perform data transmission.

4. The method according to claim 2, wherein the target timer is associated with the terminal device or associated with a medium access control entity.

5. The method according to claim 4, wherein the entering, by a terminal device, a low-power receiver state based on information of a target timer comprises:
if the target timer is associated with the terminal device, entering, by the terminal device, the low-power receiver state through turning off all primary receivers; or
if the target timer is associated with the medium access control entity, entering, by the terminal device, the low-power receiver state through turning off a primary receiver of a cell group corresponding to the medium access control entity associated with the target timer.

6. The method according to claim 4, wherein the medium access control entity comprises a master cell group medium access control entity and/or a secondary cell group medium access control entity.

7. The method according to claim 2, wherein the target timer is started or restarted when a discontinuous reception group of the terminal device enters a long discontinuous reception cycle.

8. The method according to claim 7, wherein entering the long discontinuous reception cycle comprises: entering the long discontinuous reception cycle from a short discontinuous reception cycle, and entering the long discontinuous reception cycle when a long discontinuous reception command medium access control control element is received.

9. The method according to claim 7, wherein the target timer is turned off when the discontinuous reception group of the terminal device enters a short discontinuous reception cycle or enters a discontinuous reception active state.

10. The method according to claim 9, wherein the discontinuous reception active state is triggered by scheduling of uplink and downlink data received in the long discontinuous reception cycle of the discontinuous reception group.

11. The method according to claim 7, wherein a timing duration of the target timer is a multiple of the long discontinuous reception cycle.

12. The method according to claim 7, wherein the entering, by a terminal device, a low-power receiver state based on information of a target timer comprises:
entering, by the terminal device, the low-power receiver state through turning off a primary receiver corresponding to the discontinuous reception group.

13. The method according to claim 2, wherein the target timer is started when the terminal device turns on the primary receiver.

14. The method according to claim 1, wherein the indication information instructs all primary receivers of the terminal device to enter the low-power receiver state, or instructs a primary receiver corresponding to any medium access control entity to enter the low-power receiver state.

15. The method according to claim 1, wherein before the entering, by a terminal device, a low-power receiver state, the method further comprises:
sending, by the terminal device, auxiliary information to the network device, wherein the auxiliary information is used to request to enter the low-power receiver state.

16. A terminal device, comprising:
a processor, a memory, a receiver, and an interface for communicating with a network device, wherein
the memory stores computer execution instructions; and
the processor executes the computer execution instructions stored in the memory, so that the processor is enabled to perform:
entering a low-power receiver state based on information of a target timer or indication information sent by a network device, wherein
at least one primary receiver of the terminal device in the low-power receiver state is in an off state.

17. The terminal device according to claim 16, wherein the entering a low-power receiver state based on information of a target timer or indication information sent by a network device comprises:
when the target timer expires, entering, by the terminal device, the low-power receiver state.

18. The terminal device according to claim 17, wherein the target timer is started or restarted when the terminal device and the network device perform data transmission.

19. A network device, comprising:
a processor, a memory, a receiver, and an interface for communicating with a terminal device, wherein
the memory stores computer execution instructions; and
the processor executes the computer execution instructions stored in the memory, so that the processor is enabled to perform:
sending indication information to a terminal device, wherein the indication information instructs the terminal device to enter a low-power receiver state, and
at least one primary receiver of the terminal device in the low-power receiver state is in an off state.

20. The network device according to claim 19, wherein before the sending indication information to a terminal device, the processor is enabled to perform:
receiving auxiliary information sent by the terminal device, wherein the auxiliary information is used to request to enter the low-power receiver state; and
determining, by the network device based on the auxiliary information and prediction information of uplink and downlink services, whether to generate the indication information.
